(19) United States
(12) Patent Application Publication
(10) Pub. No.: US 2021/0094335 A1
(43) Pub. Date: Apr. 1, 2021

(54) THERMAL TRANSFER IMAGE-RECEIVING SHEET AND METHOD FOR PRODUCING PRINT

(71) Applicant: Dai Nippon Printing Co., Ltd., Shinjuku-ku, Tokyo (JP)

(72) Inventors: Yusaku AKIYAMA, Shinjuku-ku, Tokyo (JP); Shigeta MORI, Shinjuku-ku, Tokyo (JP)

(73) Assignee: Dai Nippon Printing Co., Ltd., Shinjuku-ku, Tokyo (JP)

(21) Appl. No.: 16/634,361

(22) PCT Filed: Jul. 26, 2018
(86) PCT No.: PCT/JP2018/028055

§ 371 Date: Jan. 27, 2020

(30) Foreign Application Priority Data
Jul. 28, 2017 (JP) 2017-147237

(51) Int. Cl. B41M 5/52; B41M 5/42

(52) U.S. Cl. CPC B41M 5/5218; B41M 2205/32; B41M 5/426

(57) ABSTRACT

Provided are a thermal transfer image-receiving sheet capable of providing a print having pearly designability and a method for producing a print.

A thermal transfer image-receiving sheet 100 including a layer constituted only by a receiving layer 2 or two or more layers including a receiving layer provided on one surface of a support 1, the receiving layer 2 being located on the outermost surface, wherein any one of layers constituting the thermal transfer image-receiving sheet contains an inorganic pigment, and when light is allowed to enter the surface on the side of the receiving layer at an incident angle of 45°, λL* between receiving angles of 110° and 15° with respect to the specular reflection angle of the incident light is 25 or more and 50 or less.

### TECHNICAL FIELD

The present invention relates to a thermal transfer image-receiving sheet and a method for producing a print.

### BACKGROUND ART

As a means for forming a print having a thermal transferred image, there is known a sublimation type thermal transfer method in which a thermal transfer sheet having a colorant layer and a thermal transfer image-receiving sheet having a receiving layer are combined, and a sublimable dye contained in the colorant layer of the thermal transfer sheet is allowed to migrate to the receiving layer of the thermal transfer image-receiving sheet by applying energy to the thermal transfer sheet to thereby obtain a print having a thermal transferred image (e.g., see Patent Literature 1).

With recent diversifying applications of prints, there is also a need to obtain prints having pearly designability, for example, photographs and the like having pearly designability, using such a sublimation type thermal transfer method. However, under the present situation, there has been provided no specific suggestion as to a thermal transfer sheet or a thermal transfer image-receiving sheet for obtaining a print having pearly designability by the sublimation type thermal transfer method.

Patent Literature 2 suggests a designability sheet of which reflected light is pearlescent and that can change hues, although obtaining a print having pearly designability using the sublimation type thermal transfer method is not the principal theme. Patent Literature 3 suggests pearly coated paper in which a white pigment coated layer containing a white pigment and an adhesive, as main components, is provided on a sheet-like article constituted by wood fibers, and a pearl pigment coated layer containing a pearl pigment and a water-soluble polymer adhesive as main components is provided on the coated layer, as a printing paper sheet having unique designability, being excellent in printability, and being applicable for offset printing. Patent Literature 4 suggests an ink for forming an inkjet ink receiving layer, which contains an aqueous binder resin, an organic solvent compatible with the binder resin, hydrophilic porous particulates, and a pearl pigment, as an ink for forming an inkjet ink receiving layer.

### CITATION LIST

### Patent Literature

Patent Literature 1: Japanese Patent Laid-Open No. 2006-182012

Patent Literature 2: Japanese Patent Laid-Open No. 5-8342

Patent Literature 3: Japanese Patent Laid-Open No. 2009-242985

Patent Literature 4: Japanese Patent Laid-Open No. 2005-1320

### SUMMARY OF INVENTION

### Technical Problem

The present invention has been made under these circumstances, and it is a major object thereof to provide a thermal transfer image-receiving sheet capable of providing a print having pearly designability and a method for producing a print having pearly designability.

### Solution to Problem

The present invention for solving the above problems is a thermal transfer image-receiving sheet including one layer constituted only by a receiving layer or two or more layers including a receiving layer provided on one surface of a support, the receiving layer being located on the outermost surface, wherein any one of layers constituting the thermal transfer image-receiving sheet contains an inorganic pigment, and when light is allowed to enter the surface on the side of the receiving layer at an incident angle of 45°, ΔL* between receiving angles of 110° and 15° with respect to the specular reflection angle of the incident light is 25 or more and 50 or less.

In the thermal transfer image-receiving sheet described above, the inorganic pigment-containing layer contains a binder resin, and when the value obtained by dividing the total mass of the inorganic pigment in the inorganic pigment-containing layer by the total mass of the binder resin is denoted as A, and the thickness of the inorganic pigment-containing layer is denoted as B (in μm), the value obtained by dividing the A by the B may be 0.18 or more and 3.2 or less. A primer layer may be provided between the support and the receiving layer, and the primer layer may contain an inorganic pigment.

In addition, the present invention for solving the above problems is a method for producing a print, comprising a step of combining the thermal transfer image-receiving sheet described above and a thermal transfer sheet having a colorant layer to form a thermal transferred image on the receiving layer of the thermal transfer image-receiving sheet.

### Advantageous Effects of Invention

According to the thermal transfer image-receiving sheet and the method for producing a print of the present invention, a print having pearly designability can be obtained.

### BRIEF DESCRIPTION OF DRAWINGS

FIG. 1 is a schematic cross-sectional view showing an exemplary thermal transfer image-receiving sheet of one embodiment.

FIG. 2 is a schematic cross-sectional view showing an exemplary thermal transfer image-receiving sheet of one embodiment.

FIG. 3 is a schematic cross-sectional view showing an exemplary thermal transfer image-receiving sheet of one embodiment.

FIG. 4 is a schematic cross-sectional view showing an exemplary thermal transfer image-receiving sheet of one embodiment.

FIG. 5 is a schematic cross-sectional view showing an exemplary thermal transfer image-receiving sheet of one embodiment.

FIG. 6 is a schematic view showing the relation among an incident angle, a specular reflection angle, and receiving angles.

### DESCRIPTION OF EMBODIMENTS

Hereinafter, embodiments of the present invention will be described with reference to the drawings. The present invention may be embodied in different aspects and should not be construed as being limited to the description of the exemplary embodiments below. In the drawings, components may be shown schematically regarding the thickness, shape and the like of each layer, compared with actual aspects, for the sake of clearer illustration. The schematic drawings are merely examples and do not limit the interpretations of the present invention in any way. In the specification of the present application and the drawings, components that have substantially the same functions as those described before with reference to previous drawings bear the identical reference signs thereto, and detailed descriptions thereof may be omitted.

### <<Thermal Transfer Image-Receiving Sheet>>

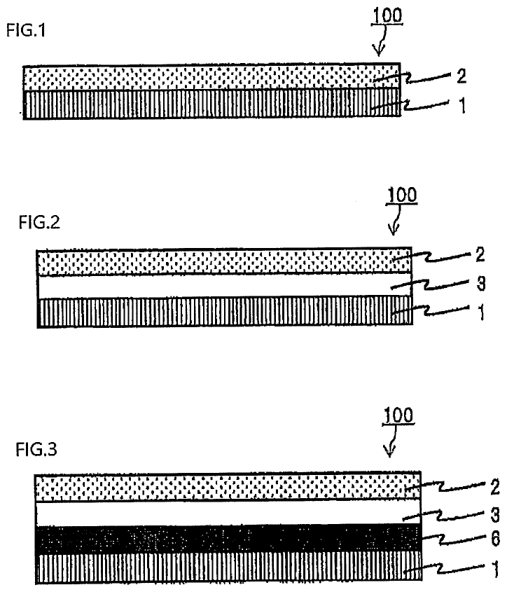

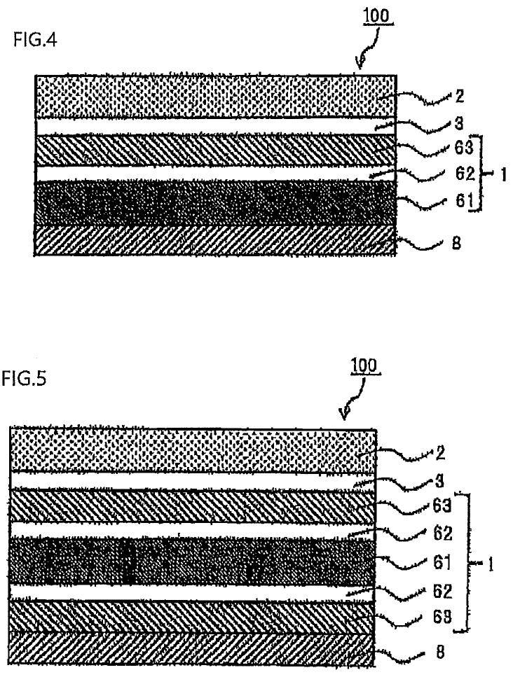

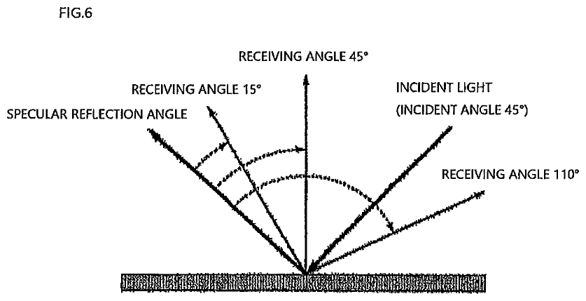

Hereinbelow, a thermal transfer image-receiving sheet according to one embodiment of the present invention (hereinbelow, referred to as the thermal transfer image-receiving sheet of one embodiment) will be described. As shown in FIGS. 1 to 5, a thermal transfer image-receiving sheet 100 of one embodiment has a structure in which one layer constituted only by a receiving layer 2 (see FIG. 1) or two or more layers including the receiving layer 2 (see FIGS. 2 to 5) are provided on one surface of a support 1 (upper surface in the form shown), and the receiving layer 2 is located on the outermost surface. FIGS. 1 to 5 are schematic cross-sectional views each showing an exemplary thermal transfer image-receiving sheet of one embodiment, and the thermal transfer image-receiving sheet 100 of the present invention is not limited to the forms shown. For example, in the thermal transfer image-receiving sheet of the forms shown in FIGS. 2 and 3, the support 1 may have a multi-layer structure, and in the thermal transfer image-receiving sheet 100 of the forms shown in FIGS. 4 and 5, the structure may not have a primer layer 3 or a back surface layer 8. Alternatively, the structure may be obtained by appropriately combining the forms of the thermal transfer image-receiving sheet 100 shown in these drawings.

In the thermal transfer image-receiving sheet 100 of one embodiment having the structure described above, any one of layers constituting the thermal transfer image-receiving sheet 100 contains an inorganic pigment, and when light is allowed to enter the surface on the side of the receiving layer 2 at an incident angle of 45°, ΔL* between receiving angles of 110° and 15° with respect to the specular reflection angle of the incident light is 25 or more and 50 or less, as shown in FIG. 6. FIG. 6 is a schematic view showing the relation of the incident angle, specular reflection angle, and receiving angles, and in the schematic view shown in FIG. 6, light is allowed to enter at an incident angle of 45° with respect to the surface of the receiving layer 2 of the thermal transfer image-receiving sheet.

Here, when light is allowed to enter the surface on the side of the receiving layer 2 of the thermal transfer image-receiving sheet 100 at an incident angle of 45°, ΔL* between receiving angles of 110° and 15° with respect to the specular reflection angle of the incident light (hereinbelow, sometimes abbreviated as ΔL* between receiving angles of 110° and 15°) will vary depending on the content of the inorganic pigment in the inorganic pigment-containing layer, the thickness of the inorganic pigment-containing layer, or the like. Accordingly, the thermal transfer image-receiving sheet 100 of one embodiment in which ΔL* between receiving angles of 110° and 15° is set to 25 or more and 50 or less can be achieved by appropriately setting the content of the inorganic pigment in the inorganic pigment-containing layer (e.g., a primer layer or a receiving layer to be mentioned below), the thickness of the inorganic pigment-containing layer (e.g., a primer layer or a receiving layer to be mentioned below), or the like. This also applies to the case where a layer other than the primer layer 3 and the receiving layer 2 contains an inorganic pigment and the case where both the receiving layer 2 and a layer other than the receiving layer 2 contain an inorganic pigment. That is, the thermal transfer image-receiving sheet 100 of one embodiment is not particularly limited with respect to conditions other than this, as long as satisfying the conditions that the receiving layer 2 is located on the outermost surface and ΔL* between receiving angles of 110° and 15° is 25 or more and 50 or less.

According to the thermal transfer image-receiving sheet 100 of one embodiment, setting ΔL* between receiving angles of 110° and 15° to 25 or more and 50 or less can impart a flip-flop property to the surface on the side of the receiving layer 2 to thereby impart pearly designability to the thermal transfer image-receiving sheet 100 of one embodiment. In other words, using the thermal transfer image-receiving sheet 100 of one embodiment and forming a thermal transferred image on the receiving layer 2 thereof by a sublimation type thermal transfer method can provide a print having pearly designability. The flip-flop property, which means the angle dependency of the lightness and hues, is a property in that the lightness and hues of the surface (the surface on the side of the receiving layer 2 of the thermal transfer image-receiving sheet referred to herein) vary depending on the viewing angle. The case of a good flip-flop property means that the degree of this variation is large.

In the present invention, ΔL* between receiving angles of 110° and 15° is set to 25 or more and 50 or less because it is not possible to impart sufficient pearly designability to the thermal transfer image-receiving sheet 100 in the case where ΔL* is less than 25 or in the case where ΔL* is more than 50. Specifically, in the case of ΔL* of less than 25, the flip-flop property of the surface on the side of the receiving layer is low and thus, it is not possible to impart sufficient pearly designability. In contrast, in the case of ΔL of more than 50, it is possible to impart a flip-flop property to the surface on the side of the receiving layer, but the designability is not pearly, but metallic.

In the thermal transfer image-receiving sheet of one embodiment, ΔL* between receiving angles of 110° and 15° is preferably 30 or more and 50 or less. According to the thermal transfer image-receiving sheet 100 of one embodiment having ΔL* between receiving angles of 110° and 15° in a preferable range, enhancing the flip-flop property can further improve the pearly designability to be imparted to the thermal transfer image-receiving sheet.

In the thermal transfer image-receiving sheet of one embodiment, the inorganic pigment-containing layer contains a binder resin. In the inorganic pigment-containing layer, when the value obtained by dividing the total mass of the inorganic pigment in the layer by the total mass of the binder resin in the layer is denoted as “A” and the thickness of the layer is denoted as “B” (in μm), the value obtained by dividing “A” by “B” (“A”/“B”) is preferably 0.18 or more and 3.2 or less, more preferably 0.4 or more and 2.5 or less. In the case where the inorganic pigment-containing layer contains two or more inorganic pigments or two or more binder resins, the total mass of the inorganic pigment described above may be read as the sum mass of the two or more inorganic pigments. The same applies to the total mass of the binder resin. In the case where two or more layers contain the inorganic pigment, only any one of the layers is required to satisfy the above relation, and all the layers more preferably satisfy the above relation.

According to the thermal transfer image-receiving sheet 100 of one embodiment structured such that the above (A/B) falls within the above preferred range, it is possible to make the pearly designability further better.

### (Calculation Method of ΔL*)

ΔL* between receiving angles of 15° and 110° referred to herein means the absolute value of the difference between L* of a receiving angle of 150 and L* of a receiving angle of 110° to be measured and calculated in compliance with JIS-Z-8781-4 (2013) in a gonio-colorimeter. As the gonio-colorimeter, a GC-2000 (NIPPON DENSHOKU INDUSTRIES CO., LTD.) was used. The incident light is set such that L* of the specular reflection angle will be 79 or more and 81 or less when the light is allowed to enter a white standard plate at an incident angle of 45°. The white standard plate used was a genuine standard plate attached to the gonio-colorimeter described above (GC-2000, NIPPON DENSHOKU INDUSTRIES CO., LTD.). The wavelength was that of a D65 light source (view angle of 2°).

Hereinbelow, the thermal transfer image-receiving sheet 100 of one embodiment will be more specifically described.

### (Support)

The support 1 of the thermal transfer image-receiving sheet 100 is not particularly limited as long as being capable of supporting the receiving layer 2. The support 1 may have a single-layer structure as shown in FIGS. 1 to 3 or may have a multi-layer structure as shown in FIGS. 4 and 5. The support 1 in the form shown in FIG. 4 has a layered structure of a substrate 61, an adhesive layer 62, and a film 63 which are layered in this order. The support 1 in the form shown in FIG. 5 has a layered structure of a film 63, an adhesive layer 62, a substrate 61, an adhesive layer 62, and a film 63 which are layered in this order. Examples of the support 1 of the single-layer structure include a support 1 constituted by a substrate 61 and a support 1 constituted by a film 63.

As an example of the substrate 61 constituting the support 1 of the multi-layer structure, wood-free paper, coated paper, resin coated paper, art paper, cast coated paper, cardboard, (polyolefin-based and polystyrene-based) synthetic paper, synthetic resin- or emulsion-impregnated paper, synthetic rubber latex-impregnated paper, synthetic resin-filled paper, cellulose fiber paper, various plastic films or sheets of polyolefins, polyvinyl chloride, polyethylene terephthalate, polystyrene, polymethacrylate, polycarbonate, and the like may be enumerated. There is no particular limitation on the thickness of the substrate 61, and the thickness thereof is usually 10 μm or more and 300 μm or less. Particularly preferably, the thickness thereof is 110 μm or more and 140 μm or less. Commercially available substrates also can be used. For example, RC paper paper (STF-150, Mitsubishi Paper Mills Limited), coated paper (AURORA COAT, NIPPON PAPER INDUSTRIES CO., LTD.), and the like can be suitably used.

As an example of the film 63 constituting the support 1 of the multi-layer structure, stretched or unstretched films of plastic, for instance, polyesters having high heat resistance such as polyethylene terephthalate and polyethylene naphthalate, polyolefins, polypropylene, polycarbonate, cellulose acetate, polyethylene derivatives, polyamides, and polymethylpentene, white opaque films obtained by adding a white pigment and a filler to these synthetic resins and forming them into a film, films having microvoids therein, and the like may be enumerated.

In the case where the support 1 has a multi-layer structure as shown in FIGS. 4 and 5, the film 63 to be layered on the side of the receiving layer 2 is preferably a film having voids. Use of a film having voids can improve the heat insulation performance of the thermal transfer image-receiving sheet 100 to thereby enable a thermal transferred image having a high density to be formed on the receiving layer 2. For a film having voids, voids (micropores) can be generated by two methods shown below. One is a method of kneading inorganic particulates into a polymer and generating microvoids using the inorganic particulates as nuclei on drawing the compound. The other is a method in which one or more incompatible polymers may be blended into a base polymer to prepare a compound. When this compound is microscopically viewed, polymer units form a fine sea-island structure. When this compound is drawn, delamination of the sea-island interface or major deformation of the polymer forming islands leads to generation of microvoids. The thickness of the film having microvoids described above is usually 10 μm or more and 100 μm or less, preferably 20 μm or more and 50 μm or less. Alternatively, as shown in FIG. 3, regardless of whether the support 1 has a multi-layer structure, a heat insulation layer 6 can be provided between the support 1 and the receiving layer 2 (between the support 1 and the primer layer 3 in the form shown in FIG. 3). As this heat insulation layer 6, a film having voids or the like can be used. Alternatively, a heat insulation layer conventionally known in the field of thermal transfer image-receiving sheets can be appropriately selected and used.

Additionally, an adhesive layer 62 may be provided between the substrate 61 and the film 63. The adhesive layer 62 for use in bonding and adhesion between the substrate 61 and the film 63 contains an adhesive and has an adhesive function. As the adhesive component, urethane resins, polyolefins such as α-olefin-maleic anhydride resins, polyesters, acrylic resins, epoxy resins, urea resins, melamine resins, phenol resins, vinyl acetate resins, cyanoacrylate resins, and the like may be enumerated. Among them, reactive-type acrylic resins, modified acrylic resins, and the like can be preferably used. Curing the adhesive by use of a curing agent is preferred because both the adhesive force and heat resistance are improved. As the curing agent, isocyanate compounds are common, but aliphatic amines, alicyclic amines, aromatic amines, acid anhydrides, and the like can be used.

The thickness of the adhesive layer 62 is usually 2 μm or more and 10 μm or less in the dried state. The adhesive layer can be formed by dispersing or dissolving the adhesive exemplified above and additives to be added as required in a suitable solvent to prepare a coating liquid for adhesive layer, coating this coating liquid onto the substrate 61, and then drying the coated liquid.

The substrate 61 and the film 63 may be bonded to each other by means of EC sandwich lamination, in which polyethylene and the like are employed, instead of bonding the substrate 61 and the film 63 to each other by use of the adhesive layer 62 described above.

### (Back Surface Layer)

As shown in FIGS. 4 and 5, a back surface layer 8 may be provided on the surface of the support 1 opposite to the side on which the receiving layer 2 is provided. The back surface layer 8 is an optional constituent in the thermal transfer image-receiving sheet 100 of one embodiment.

As the back surface layer 8, those which have a desired function can be appropriately selected and used depending on the applications and the like of the thermal transfer image-receiving sheet 100 of one embodiment. Among them, preferably used is a back surface layer 8 having a function of improving conveyance of the thermal transfer image-receiving sheet 100, an anti-curl function, and writability. As the back surface layer 8 having such functions, it is possible to use those in which an organic filler such as nylon filler, acrylic filler, polyamide filler, fluorine filler, polyethylene wax, or amino acid-based powder, or an inorganic filler such as silicon dioxide or a metal oxide is added as an additive in a resin such as an acrylic resin, cellulose resin, polycarbonate, polyvinyl acetal, polyvinyl alcohol, polyamide, polystyrene, polyester, halogenated polymer, or the like. Alternatively, as the back surface layer, it is possible to use those obtained by curing these resins by use of a curing agent such as an isocyanate compound or a chelating compound. The thickness of the back surface layer 8 is usually 0.1 μm or more and 20 nm or less, preferably 0.5 μm or more and 10 μm or less. A back surface primer layer (not shown) may be provided between the support 1 and the back surface layer 8.

Next, the thermal transfer image-receiving sheet 100 of one embodiment in which one layer constituted only by a receiving layer 2 or two or more layers including the receiving layer 2 are provided on one surface of the support 1 will be described. In a concrete manner, a form in which the receiving layer 2 contains an inorganic pigment (first embodiment) and a form in which a layer different from the receiving layer 2 contains an inorganic pigment (second embodiment) will be separately described. In the thermal transfer image-receiving sheet 100 of any of forms exemplified below, when light is allowed to enter the surface on the side of the receiving layer 2 of the thermal transfer image-receiving sheet 100, ΔL* between receiving angles of 110° and 15° with respect to the specular reflection angle of the incident light is 25 or more and 50 or less.

### (Thermal Transfer Image-Receiving Sheet of First Embodiment)

The thermal transfer image-receiving sheet of the first embodiment has a structure in which only the receiving layer 2 is provided on one surface of the support 1, as shown in FIG. 1, or a structure in which two or more layers including the receiving layer 2 are provided on one surface of the support 1, as shown in FIGS. 2 to 5. The receiving layer 2 contains a binder resin having a dye-receiving ability and an inorganic pigment. In the thermal transfer image-receiving sheet 100 of the first embodiment, it is provided that the receiving layer 2 contains an inorganic pigment. In the thermal transfer image-receiving sheet 100 of the structures each shown in FIGS. 2 to 5, in addition to the receiving layer 2, a layer other than the receiving layer 2 may contain the inorganic pigment.

As the binder resin having a dye-receiving ability, polyolefins such as polypropylene, halogenated resins such as polyvinyl chloride or polyvinylidene chloride, vinyl resins such as polyvinyl acetate, vinyl chloride-vinyl acetate copolymers, ethylene-vinyl acetate copolymers, or polyacrylic esters, polyesters such as polyethylene terephthalate or polybutylene terephthalate, copolymers of an olefin such as polystyrene, polyamide, ethylene or propylene and another vinyl polymer, polycarbonate, and the like may be enumerated. The receiving layer 2 may contain one binder resin having a dye-receiving ability or may contain two or more such resins.

There is no particular limitation on the inorganic pigment, and an inorganic pigment may be appropriately selected that can achieve ΔL* between receiving angles of 110° and 15° with respect to the specular reflection angle of the incident light of 25 or more and 50 or less, when the light is allowed to enter the surface on the side of the receiving layer 2 of thermal transfer image-receiving sheet 100 of the first embodiment. As the inorganic pigment, oxide-coated micas such as titanium oxide-coated silica, mica titanium, iron-oxide coated mica, iron-oxide coated mica titanium, Prussian blue-coated mica titanium, Prussian blue-iron oxide-coated mica titanium, chromium oxide-coated mica titanium, carmine-coated mica titanium, organic pigment-coated mica titanium, titanium oxide-coated mica, and titanium oxide-coated synthetic mica; oxide-coated glass powders such as titanium oxide-coated glass powder and iron-oxide coated glass powder; oxide-coated metal particles such as titanium oxide-coated aluminum powder; scaly foil segments such as basic lead oxide, lead hydrogen arsenate, and bismuth oxychloride; pearl pigments such as fish scale powder, shell fragments, and pearl fragments, and metal pigments such as aluminum powder, gold powder, silver powder, copper powder, bronze powder, zinc powder, stainless powder, and nickel powder, and the like may be enumerated. Among these, a silver pearl pigment that exhibits a silver color is a suitable inorganic pigment in that the pigments can further improve the pearly designability. Additionally, in the case where a photographic image is formed on the thermal transfer image-receiving sheet of the present disclosure, employing the silver pearl pigment as the inorganic pigment can impart pearly designability without impairing the photographic image. Examples of the silver pearl pigment include those obtained by coating the surface of mica, synthetic mica, silica, or the like with a coating layer constituted by titanium oxide. The thickness of the coating layer is preferably 40 nm or more and 100 nm or less.

The content of the inorganic pigment contained in the receiving layer 2 in the thermal transfer image-receiving sheet 100 of the first embodiment is not particularly limited. The content may be determined, in consideration of the thickness of the inorganic pigment-containing layer and the like, such that ΔL* between receiving angles of 110° and 15° is 25 or more and 50 or less. The same applies to the particle size of the inorganic pigment.

The receiving layer 2 of the thermal transfer image-receiving sheet 100 of the first embodiment contains, as an example, 5% by mass or more and 80% by mass or less of the inorganic pigment based on the total mass of the receiving layer 2. The particle size of the inorganic pigment is, as an example, 1 μm or more and 200 μm or less.

There is no particular limitation on the method for producing the receiving layer 2 of the thermal transfer image-receiving sheet 100 of the first embodiment. The receiving layer 2 can be formed by dispersing or dissolving a binder resin having die-receiving ability, an inorganic pigment, and optional additives to be added as required in a suitable solvent to prepare a coating liquid for receiving layer, coating this coating liquid onto the support 1 or an optional layer to be provided on the support 1 (e.g., primer layer 3), and then drying the coated liquid. There is no particular limitation on the method for coating the coating liquid for receiving layer, and any conventionally known coating method can be selected appropriately and used. As the coating method, for example, the gravure printing method, the screen printing method, the reverse roll coating method using a gravure plate, and the like may be enumerated. Coating methods other than these methods may also be used. This applies to coating methods of various coating liquids.

### (Thermal Transfer Image-Receiving Sheet of Second Embodiment)

In the thermal transfer image-receiving sheet of the second embodiment, two or more layers including the receiving layer 2 are provided on one surface of the support 1, as shown in FIGS. 2 to 5. Among layers constituting the thermal transfer image-receiving sheet 100, the layers other than the receiving layer 2 contain an inorganic pigment.

According to the thermal transfer image-receiving sheet 100 of the second embodiment, use of the thermal transfer image-receiving sheet 100 enables a thermal transferred image having a high density to be formed and the smoothness of the surface of the receiving layer 2 to be improved.

Specifically, according to the thermal transfer image-receiving sheet 100 of the second embodiment, it is possible to impart pearly designability to the thermal transfer image-receiving sheet 100 while reducing or zeroing the content of the inorganic pigment contained in the receiving layer 2. As a result, it is possible to increase the content of the binder resin having die-receiving ability based on the total mass of the receiving layer 2. That is, according to the thermal transfer image-receiving sheet 100 of the second embodiment, the content of the inorganic pigment contained in the receiving layer 2 can be appropriately adjusted. Therefore, it is possible to form a thermal transferred image having a high density on the receiving layer 2.

The smoothness of the surface of the receiving layer 2 decreases due to the protrusion amount of the inorganic pigment protruding from the surface of the receiving layer 2. Thus, for the same reason as described above, according to the thermal transfer image-receiving sheet 100 of the second embodiment, it is possible to reduce the inorganic pigment protruding from the surface of the receiving layer 2 and to improve the smoothness of the surface of the receiving layer 2. Improving the smoothness of the receiving layer 2 can further improve the designability having a pearl tone. Note that this does not exclude forms in which the receiving layer 2 contains an inorganic pigment. Both the receiving layer 2 and layers other than receiving layer 2 of a thermal transfer image-receiving sheet may contain the inorganic pigment. That is, the receiving layer 2 in the second embodiment may be the receiving layer 2 described for the thermal transfer image-receiving sheet 100 of the first embodiment, or may be a receiving layer 2 obtained by removing the inorganic pigment from the receiving layer 2 described for the thermal transfer image-receiving sheet 100 of the first embodiment.

In the thermal transfer image-receiving sheet 100 of the second embodiment, the receiving layer 2 contains no inorganic pigment, or even if an inorganic pigment is contained, the content thereof is preferably 30% by mass or less, more preferably 10% by mass or less, particularly preferably 5% by mass or less, based on the total mass of the receiving layer 2.

In a preferred thermal transfer image-receiving sheet 100 of the second embodiment, a primer layer 3 is provided between the support 1 and the receiving layer 2, as shown in FIGS. 2 to 5, and the primer layer 3 contains a binder resin and an inorganic pigment.

There is no particular limitation on the inorganic pigment contained in the primer layer 3, and those exemplified for the inorganic pigment contained in the receiving layer 2 described above can be appropriately selected and used. The same applies to the case where a layer other than the primer layer 3 contains an inorganic pigment.

The primer layer 3, as an example, contains 5% by mass or more and 80% by mass or less of the inorganic pigment based on the total mass of the primer layer 3. The particle size of the inorganic pigment is, as an example, 1 μm or more and 200 μm or less.

There is no particular limitation on the binder resin contained in the primer layer 3, and polyurethane, acrylic resins, polyethylene, polypropylene, epoxy resins, polyesters, and the like may be enumerated. Binder resins having adhesion other than this also may be appropriately selected and used. The primer layer 3 may contain one binder resin singly or may contain two or more binder resins. The primer layer 3 may be an aqueous dispersion-based primer layer or may be a solvent dispersion-based primer layer.

There is no particular limitation on the thickness of the primer layer 3. The thickness thereof is preferably 0.1 μm or more and 20 μm or less, more preferably 0.2 μm or more and 6 μm or less, still more preferably 0.4 μm or more and 3 μm or less. Particularly, the primer layer 3 having the thickness described above preferably contains a silver pearl pigment as the inorganic pigment. In the case where the primer layer 3 contains an inorganic pigment other than the silver pearl pigment as the inorganic pigment, the thickness of the primer layer 3 is preferably 1.2 μm or more and 6 μm or less, more preferably 1.5 μm or more and 3 μm or less.

In the thermal transfer image-receiving sheet 100 of the second embodiment, the primer layer 3 contains an inorganic pigment, and when the value obtained by dividing the total mass of the inorganic pigment contained in the primer layer 3 by the total mass of the binder resin contained in the primer layer 3 is denoted as “A” and the thickness of the primer layer 3 is denoted as “B” (in μm), the value obtained by dividing “A” by “B” (“A”/“B”) is preferably 0.2 or more and 3 or less, more preferably 0.6 or more and 3 or less, still more preferably 0.7 or more and 2 or less. Particularly, the inorganic pigment contained in the primer layer when the above relation is satisfied is preferably is a silver pearl pigment. According to the thermal transfer image-receiving sheet 100 of the second embodiment, wherein the primer layer 3 is such that the relation among the content of the inorganic pigment, the content of the binder resin, and the thickness of the primer layer 3 satisfies the relation described above, and when light is allowed to enter the surface on the side of the receiving layer 2 at an incident angle of 45°, ΔL* between receiving angles of 110° and 15° with respect to the specular reflection angle of the incident light is set to 25 or more and 50 or less, it is possible to make the pearly designability very good.

Additionally, “A” as the value obtained by dividing the total mass of the inorganic pigment contained in the primer layer 3 described above by the total mass of the binder resin contained in the primer layer 3 is preferably 0.05 or more and 6 or less, more preferably 0.4 or more and 4 or less.

There is no particular limitation on the method for producing the primer layer. The primer layer can be formed by dispersing or dissolving a binder resin, an inorganic pigment (in the case of a form where the primer layer contains an inorganic pigment), and optional additives to be added as required in a suitable solvent to prepare a coating liquid for primer layer, coating this coating liquid onto the support 1 or an optional layer to be provided on the support 1 (heat insulation layer 6 in the form shown in FIG. 3), and then drying the coated liquid.

The thermal transfer image-receiving sheets of the first embodiment and the second embodiment have been described hereinabove. A thermal transfer image-receiving sheet 200 may have various functional layers, for example, a barrier layer for imparting solvent resistance (not shown) and the like. Instead of or in addition to allowing the receiving layer 2 or the primer layer 3 described above to contain an inorganic pigment, various functional layers are allowed to contain an inorganic pigment to set ΔL* between receiving angles of 110° and 15° to 25 or more and 50 or less.

### <<Method for Producing Print>>

Next, a method for producing a print according to an embodiment of the present invention (hereinbelow, it is referred to as a method for producing a print of one embodiment) will be described. The method for producing a print of one embodiment includes a step of combining a thermal transfer image-receiving sheet 100 having a receiving layer 2 and a thermal transfer sheet having a colorant layer to form a thermal transferred image on the receiving layer 2 using a heating device such as a thermal head. Then, in the method for producing a print of one embodiment, the thermal transfer image-receiving sheet 100 of one embodiment described above is used as the thermal transfer image-receiving sheet having the receiving layer 2.

According to the method for producing a print of one embodiment, a print having pearly designability can be obtained using a sublimation type thermal transfer method.

As the thermal transfer sheet having a colorant layer, a conventionally known thermal transfer sheet can be appropriately selected and used.

The method for producing a print of one embodiment may also include, for example, a step of forming a protective layer on the receiving layer 2 after the thermal transferred image is formed on the receiving layer. The method may include steps other than this step.

### EXAMPLES

Hereinbelow, the thermal transfer image-receiving sheet according to the embodiments of the present invention will be described with reference to examples and comparative examples. Note that the expression of “part(s)” herein means that by mass, unless otherwise specified. Note that the amount of a component to be blended shown with its solid content ratio indicates the mass before converted to the solid content.

### Example 1

A coating liquid for primer layer 1 having the following composition was coated onto the surface side of a porous polyolefin film (surface side: polyolefin resin layer) having a thickness of 35 μm by a gravure coater so as to obtain a thickness of 1.1 μm in the dried state, and then the coated liquid was dried at 110° C. for one minute to form a primer layer. Next, a coating liquid for receiving layer 1 having the following composition was coated onto the primer layer by a gravure coater so as to obtain a thickness of 4 μm in the dried state, and then the coated liquid was dried at 110° C. for one minute to form a receiving layer. Thus, a laminate was obtained in which the porous polyolefin film, the primer layer, and the receiving layer were layered in this order.

As a substrate, an RC paper having a thickness of 190 μm (Mitsubishi Paper Mills Limited) was used. A coating liquid for adhesive layer having the following composition was coated onto the substrate by a gravure coater so as to obtain a thickness of 5 μm in the dried state to form a coated film for adhesive layer. The laminate obtained above was bonded there to such that the coated film for adhesive layer was opposed to the polyolefin film to thereby obtain a thermal transfer image-receiving sheet of Example 1.

### <Coating Liquid for Primer Layer 1>

| | |
|---|---|
| Urethane resin (solid content ratio 30%) | 40 parts |
| (NIPPOLAN 5199, TOSOH CORPORATION) | |
| Silver pearl pigment (particle size: 5 to 25 μm) | 24 parts |
| (Iriodin(R)123 Bright Luster Satin, Merck & Co., Inc.) | |
| Methyl ethyl ketone | 76 parts |
| Toluene | 76 parts |

### <Coating Liquid for Receiving Layer 1>

| | |
|---|---|
| Vinyl chloride - vinyl acetate copolymer | 20 parts |
| (SOLBIN(R) CNL, Nissin Chemical Co., Ltd.) | |
| Epoxy aralkyl-modified silicone oil | 0.4 parts |
| (X-22-3000T, Shin-Etsu Chemical Co., Ltd.) | |
| Methyl ethyl ketone | 70 parts |
| Toluene | 70 parts |

<Coating liquid for adhesive layer>

| | |
|---|---|
| Polyfunctional polyol | 30 parts |
| (TAKELAC(R) A-969V, Mitsui Chemicals, Inc.) | |
| Isocyanate | 10 parts |
| (TAKENATE(R) A-5, Mitsui Chemicals, Inc.) | |
| Ethyl acetate | 60 parts |

### Example 2

A thermal transfer image-receiving sheet of Example 2 was obtained exactly in the same manner as in Example 1 except that the coating liquid for primer layer 1 having the above composition was coated by a gravure coater so as to obtain a thickness of 2 μm in the dried state and then, the coated liquid was dried at 110° C. for one minute to thereby form the primer layer.

### Example 3

A thermal transfer image-receiving sheet of Example 3 was obtained exactly in the same manner as in Example 1 except that the coating liquid for primer layer 1 having the above composition was coated by a gravure coater so as to obtain a thickness of 2.5 μm in the dried state and then, the coated liquid was dried at 110° C. for one minute to thereby form the primer layer.

### Example 4

A thermal transfer image-receiving sheet of Example 4 was obtained exactly in the same manner as in Example 1 except that the coating liquid for primer layer 1 was replaced by a coating liquid for primer layer 2 having the following composition, the coating liquid for primer layer 2 was coated by a gravure coater so as to obtain a thickness of 2 μm in the dried state and then, the coated liquid was dried at 110° C. for one minute to thereby form the primer layer.

### <Coating Liquid for Primer Layer 2>

| | |
|---|---|
| Urethane resin (solid content ratio 30%) | 40 parts |
| (NIPPOLAN 5199, TOSOH CORPORATION) | |
| Silver pearl pigment (particle size: 5 to 25 μm) | 12 parts |
| (Iriodin(R)123 Bright Luster Satin, Merck & Co., Inc.) | |
| Methyl ethyl ketone | 46 parts |
| Toluene | 46 parts |

### Example 5

A thermal transfer image-receiving sheet of Example 5 was obtained exactly in the same manner as in Example 1 except that a coating liquid for primer layer 3 having the following composition, instead of the coating liquid for primer layer 1, was coated by a gravure coater so as to obtain a thickness of 2 μm in the dried state and then, the coated liquid was dried at 110° C. for one minute to thereby form the primer layer.

### <Coating Liquid for Primer Layer 3>

| | |
|---|---|
| Urethane resin (solid content ratio 30%) | 40 parts |
| (NIPPOLAN 5199, TOSOH CORPORATION) | |
| Silver pearl pigment (particle size: 5 to 25 μm) | 6 parts |
| (Iriodin(R) 123 Bright Luster Satin, Merck & Co., Inc.) | |
| Methyl ethyl ketone | 31 parts |
| Toluene | 31 parts |

### Example 6

A thermal transfer image-receiving sheet of Example 6 was obtained exactly in the same manner as in Example 1 except that a coating liquid for primer layer 4 having the following composition, instead of the coating liquid for primer layer 1, was coated by a gravure coater so as to obtain a thickness of 2 μm in the dried state and then, the coated liquid was dried at 110° C. for one minute to thereby form the primer layer.

### <Coating Liquid for Primer Layer 4>

| | |
|---|---|
| Urethane resin (solid content ratio 30%) | 40 parts |
| (NIPPOLAN 5199, TOSOH CORPORATION) | |
| Silver pearl pigment (particle size: 1 to 15 μm) | 24 parts |
| (Iriodin(R) 111 Rutile Fine Satin, Merck & Co., Inc.) | |
| Methyl ethyl ketone | 76 parts |
| Toluene | 76 parts |

### Example 7

A thermal transfer image-receiving sheet of Example 7 was obtained exactly in the same manner as in Example 1 except that a coating liquid for primer layer 5 having the following composition, instead of the coating liquid for primer layer 1, was coated by a gravure coater so as to obtain a thickness of 2 μm in the dried state and then, the coated liquid was dried at 110° C. for one minute to thereby form the primer layer.

### <Coating Liquid for Primer Layer 5>

| | |
|---|---|
| Urethane resin (solid content ratio 30%) | 40 parts |
| (NIPPOLAN 5199, TOSOH CORPORATION) | |
| Silver pearl pigment (particle size: 10 to 60 μm) | 24 parts |
| (Iriodin(R) 100 Silver Pearl, Merck & Co., Inc.) | |
| Methyl ethyl ketone | 76 parts |
| Toluene | 76 parts |

### Example 8

A thermal transfer image-receiving sheet of Example 8 was obtained exactly in the same manner as in Example 1 except that a coating liquid for primer layer 1 was replaced by a coating liquid for primer layer 6 having the following composition to form the primer layer.

### <Coating Liquid for Primer Layer 6>

| | |
|---|---|
| Urethane resin (solid content ratio 30%) | 40 parts |
| (NIPPOLAN 5199, TOSOH CORPORATION) | |
| Green pearl pigment (particle size: 5 to 50 μm) | 24 parts |
| (Colorstream(R) T10-02 Arctic Fire, Merck & Co., Inc.) | |
| Methyl ethyl ketone | 76 parts |
| Toluene | 76 parts |

### Example 9

A thermal transfer image-receiving sheet of Example 9 was obtained exactly in the same manner as in Example 1 except that the coating liquid for primer layer 6 having the above composition, instead of the coating liquid for primer layer 1, was coated by a gravure coater so as to obtain a thickness of 2 μm in the dried state and then, the coated liquid was dried at 110° C. for one minute to thereby form the primer layer.

### Example 10

A thermal transfer image-receiving sheet of Example 10 was obtained exactly in the same manner as in Example 1 except that the coating liquid for primer layer 6 having the above composition, instead of the coating liquid for primer layer 1, was coated by a gravure coater so as to obtain a thickness of 2.5 μm in the dried state and then, the coated liquid was dried at 110° C. for one minute to thereby form the primer layer.

### Example 11

A thermal transfer image-receiving sheet of Example 11 was obtained exactly in the same manner as in Example 1 except that a coating liquid for primer layer 7 having the following composition, instead of the coating liquid for primer layer 1, was coated by a gravure coater so as to obtain a thickness of 2 μm in the dried state and then, the coated liquid was dried at 110° C. for one minute to thereby form the primer layer.

### <Coating Liquid for Primer Layer 7>

| | |
|---|---|
| Urethane resin (solid content ratio 30%) | 40 parts |
| (NIPPOLAN 5199, TOSOH CORPORATION) | |
| Green pearl pigment (particle size: 5 to 50 μm) | 12 parts |
| (Colorstream(R) T10-02 Arctic Fire, Merck & Co., Inc.) | |
| Methyl ethyl ketone | 46 parts |
| Toluene | 46 parts |

### Example 12

A thermal transfer image-receiving sheet of Example 12 was obtained exactly in the same manner as in Example 1 except that the coating liquid for receiving layer 1 was changed to a coating liquid for receiving layer 2 having the following composition to thereby form the receiving layer and that a coating liquid for primer layer 8 having the following composition, instead of the coating liquid for primer layer 1, was coated by a gravure coater so as to obtain a thickness of 2 μm in the dried state and then, the coated liquid was dried at 110° C. for one minute to thereby form the primer layer.

### <Coating Liquid for Receiving Layer 2>

| | | |
|---|---|---|
| Vinyl chloride - vinyl acetate copolymer | 6.7 | parts |
| (SOLBIN(R) CNL, Nissin Chemical Co., Ltd.) | | |
| Epoxy aralkyl-modified silicone oil | 0.4 | parts |
| (X-22-3000T, Shin-Etsu Chemical Co., Ltd.) | | |
| Silver pearl pigment (particle size: 5 to 25 μm) | 13.4 | parts |
| (Iriodin(R)123 Bright Luster Satin, Merck & Co., Inc.) | | |
| Methyl ethyl ketone | 70 | parts |
| Toluene | 70 | parts |

### <Coating Liquid for Primer Layer 8>

| | |
|---|---|
| Urethane resin (solid content ratio 30%) | 40 parts |
| (NIPPOLAN 5199, TOSOH CORPORATION) | |
| Titanium oxide | 24 parts |
| (TCA888, Tohkem Products Corporation) | |
| Methyl ethyl ketone | 76 parts |
| Toluene | 76 parts |

### Example 13

A thermal transfer image-receiving sheet of Example 10 was obtained exactly in the same manner as in Example 1 except that the coating liquid for primer layer 1 was coated by a gravure coater so as to obtain a thickness of 0.6 μm in the dried state and then, the coated liquid was dried at 110° C. for one minute to thereby form the primer layer.

### Example 14

A thermal transfer image-receiving sheet of Example 14 was obtained exactly in the same manner as in Example 1 except that a coating liquid for primer layer 9 having the following composition, instead of the coating liquid for primer layer 1, was coated by a gravure coater so as to obtain a thickness of 2.5 μm in the dried state and then, the coated liquid was dried at 110° C. for one minute to thereby form the primer layer.

### <Coating Liquid for Primer Layer 9>

| | |
|---|---|
| Urethane resin (solid content ratio 30%) | 50 parts |
| (NIPPOLAN 5199, TOSOH CORPORATION) | |
| Silver pearl pigment (particle size: 5 to 25 μm) | 6 parts |
| (Iriodin(R)123 Bright Luster Satin, Merck & Co., Inc.) | |
| Methyl ethyl ketone | 57 parts |
| Toluene | 57 parts |

### Example 15

A thermal transfer image-receiving sheet of Example 15 was obtained exactly in the same manner as in Example 1 except that the coating liquid for primer layer 1 was replaced by a coating liquid for primer layer 10 having the following composition, the coating liquid for primer layer 10 was coated by a gravure coater so as to obtain a thickness of 2 μm in the dried state, and then, the coated liquid was dried at 110° C. for one minute to thereby form the primer layer.

### <Coating Liquid for Primer Layer 10>

| | |
|---|---|
| Polyester (solid content ratio 25%) | 48 parts |
| (VYLONAL(R) MD1480, TOYOBO CO., LTD.) | |
| Silver pearl pigment (particle size: 5 to 25 μm) | 24 parts |
| (Iriodin(R)123 Bright Luster Satin, Merck & Co., Inc.) | |
| Methyl ethyl ketone | 72 parts |
| Toluene | 72 parts |

### Example 16

A thermal transfer image-receiving sheet of Example 16 was obtained exactly in the same manner as in Example 1 except that the coating liquid for primer layer 1 was replaced by the coating liquid for primer layer 7 having the above composition, the coating liquid for primer layer 7 was coated by a gravure coater so as to obtain a thickness of 1 μm in the dried state, and then, the coated liquid was dried at 110° C. for one minute to thereby form the primer layer.

### Example 17

A thermal transfer image-receiving sheet of Example 17 was obtained exactly in the same manner as in Example 1 except that the coating liquid for primer layer 1 was replaced by the coating liquid for primer layer 3 having the above composition, the coating liquid for primer layer 3 was coated by a gravure coater so as to obtain a thickness of 0.5 μm in the dried state, and then, the coated liquid was dried at 110° C. for one minute to thereby form the primer layer.

### Example 18

A thermal transfer image-receiving sheet of Example 18 was obtained exactly in the same manner as in Example 1 except that the coating liquid for primer layer 1 was replaced by a coating liquid for primer layer 11 having the following composition, the coating liquid for primer layer 11 was coated by a gravure coater so as to obtain a thickness of 2.5 μm in the dried state, and then, the coated liquid was dried at 110° C. for one minute to thereby form the primer layer.

### <Coating Liquid for Primer Layer 11>

| | |
|---|---|
| Urethane resin (solid content ratio 30%) | 50 parts |
| (NIPPOLAN 5199, TOSOH CORPORATION) | |
| Silver pearl pigment (particle size: 5 to 25 μm) | 45 parts |
| (Iriodin(R)123 Bright Luster Satin, Merck & Co., Inc.) | |
| Methyl ethyl ketone | 102 parts |
| Toluene | 102 parts |

### Example 19

A thermal transfer image-receiving sheet of Example 19 was obtained exactly in the same manner as in Example 1 except that the coating liquid for primer layer 1 was replaced by a coating liquid for primer layer 12 having the following composition, the coating liquid for primer layer 12 was coated by a gravure coater so as to obtain a thickness of 5 μm in the dried state, and then, the coated liquid was dried at 110° C. for one minute to thereby form the primer layer.

### <Coating Liquid for Primer Layer 12>

| | |
|---|---|
| Urethane resin (solid content ratio 30%) | 20 parts |
| (NIPPOLAN 5199, TOSOH CORPORATION) | |
| Silver pearl pigment (particle size: 5 to 25 μm) | 30 parts |
| (Iriodin(R)123 Bright Luster Satin, Merck & Co., Inc.) | |
| Methyl ethyl ketone | 41 parts |
| Toluene | 41 parts |

### Example 20

A thermal transfer image-receiving sheet of Example 20 was obtained exactly in the same manner as in Example 1 except that the coating liquid for primer layer 1 was replaced by the coating liquid for primer layer 7 having the above composition, the coating liquid for primer layer 7 was coated by a gravure coater so as to obtain a thickness of 5 μm in the dried state and then, the coated liquid was dried at 110° C. for one minute to thereby form the primer layer.

### Example 21

A thermal transfer image-receiving sheet of Example 21 was obtained exactly in the same manner as in Example 1 except that the coating liquid for primer layer 1 was replaced by a coating liquid for primer layer 13 having the following composition, the coating liquid for primer layer 13 was coated by a gravure coater so as to obtain a thickness of 0.3 μm in the dried state, and then, the coated liquid was dried at 110° C. for one minute to thereby form the primer layer.

### <Coating Liquid for Primer Layer 13>

| | |
|---|---|
| Urethane resin (solid content ratio 30%) | 40 parts |
| (NIPPOLAN 5199, TOSOH CORPORATION) | |
| Silver pearl pigment (particle size: 5 to 25 μm) | 1.2 parts |
| (Iriodin(R)123 Bright Luster Satin, Merck & Co., Inc.) | |
| Methyl ethyl ketone | 32 parts |
| Toluene | 32 parts |

### Example 22

A thermal transfer image-receiving sheet of Example 22 was obtained exactly in the same manner as in Example 1 except that the coating liquid for primer layer 1 was replaced by the coating liquid for primer layer 12 having the above composition, the coating liquid for primer layer 12 was coated by a gravure coater so as to obtain a thickness of 1.7 μm in the dried state and then, the coated liquid was dried at 110° C. for one minute to thereby form the primer layer.

### Comparative Example 1

A thermal transfer image-receiving sheet of Comparative Example 1 was obtained exactly in the same manner as in Example 1 except that a coating liquid for primer layer 14 having the following composition, instead of the coating liquid for primer layer 1, was coated by a gravure coater so as to obtain a thickness of 2 μm in the dried state and then, the coated liquid was dried at 110° C. for one minute to thereby form the primer layer.

### <Coating Liquid for Primer Layer 14>

| | |
|---|---|
| Urethane resin (solid content ratio 30%) | 40 parts |
| (NIPPOLAN 5199, TOSOH CORPORATION) | |
| Aluminum pigment | 24 parts |
| Methyl ethyl ketone | 76 parts |
| Toluene | 76 parts |

### Comparative Example 2

A thermal transfer image-receiving sheet of Comparative Example 2 was obtained exactly in the same manner as in Example 1 except that the coating liquid for primer layer 8 having the above composition, instead of the coating liquid for primer layer 1, was coated by a gravure coater so as to obtain a thickness of 2 μm in the dried state and then, the coated liquid was dried at 110° C. for one minute to thereby form the primer layer.

### (Calculation of ΔL* Between Receiving Angles of 110° and 15°)

In accordance with the calculation method of ΔL* described above, ΔL* of the surface on the side of the receiving layer of the thermal transfer image-receiving sheet of each of Examples and Comparative Examples was calculated, based on the absolute value of the difference between L* of a receiving angle of 15° and L* of a receiving angles of 110θ measured and calculated by means of a gonio-colorimeter (GC-2000, NIPPON DENSHOKU INDUSTRIES CO., LTD.). The results are shown in Table 1. All the thermal transfer image-receiving sheets of Examples had ΔL* between receiving angles of 15° and 110° of 25 or more and 50 or less, whereas ΔL* between receiving angles of 15° and 110° of the thermal transfer image-receiving sheet of Comparative Example 1 was more than 50, and ΔL* between receiving angles of 15° and 110° of the thermal transfer image-receiving sheet of Comparative Example 2 was less than 25.

### (Pearly Feeling Evaluation)

The surface on the side of the receiving layer of the thermal transfer image-receiving sheet of each of Examples and Comparative Examples was visually observed, and its pearly feeling was evaluated based on the following evaluation criteria. The evaluation results are also shown in table 1.

### “Evaluation Criteria”

A: Having greatly high pearly designability
B: Having high pearly designability
C: Having pearly designability
NG: Having no pearly designability

### (Density Evaluation)

By using a sublimable type thermal transfer printer (DS40, Dai Nippon Printing Co., Ltd.) and combining a ribbon meant for the printer (as a thermal transfer sheet) and the thermal transfer image-receiving sheet of each of Examples and Comparative Examples obtained above, a yellow colorant layer, a magenta colorant layer, and a cyan colorant layer were printed in this order to form a black image (0/255 gradation image). The reflection density of the black image formed was measured by means of a spectrometer (i1X-Rite Inc.), and the density was evaluated based on the following criteria. The evaluation results are shown in Table 1.

### “Evaluation Criteria”

When the reflection density of Comparative Example 2 is taken as the reference reflection density,

A: the reflection density is 0.95 times or more the reference reflection density.
B: the reflection density is less than 0.95 times the reference reflection density.

### (Graininess Evaluation)

By using a sublimable type thermal transfer printer (DS40, Dai Nippon Printing Co., Ltd.) and combining a ribbon meant for the printer (as a thermal transfer sheet) and the thermal transfer image-receiving sheet of each of Examples and Comparative Examples obtained above, a gray solid image (128/255 gradation image) was formed on the receiving layer of the thermal transfer image-receiving sheet to thereby obtain a print of each of Examples and Comparative Examples. The condition of the surface of the print obtained was visually observed, and the graininess of each of Examples and Comparative Examples was evaluated based on the following evaluation criteria.

### “Evaluation Criteria”

A: The surface of the print has no graininess.
B: The surface of the print has graininess, but there is no problem for an image.
NG: Graininess of the print appears as image defects.

TABLE 1

| | ΔL* | A(*1) | B(μm)(*2) | A/B(*3) | Pearly feeling | Density | Graininess |
|---|---|---|---|---|---|---|---|
| Example 1 | 35.9 | 2.0 | 1.1 | 1.82 | A | A | A |
| Example 2 | 38.3 | 2.0 | 2.0 | 1.00 | A | A | A |
| Example 3 | 38.8 | 2.0 | 2.5 | 0.80 | A | A | A |
| Example 4 | 32.8 | 1.0 | 2.0 | 0.50 | B | A | A |
| Example 5 | 32.3 | 0.5 | 2.0 | 0.25 | B | A | A |
| Example 6 | 31.5 | 2.0 | 2.0 | 1.00 | A | A | A |
| Example 7 | 34.9 | 2.0 | 2.0 | 1.00 | A | A | A |
| Example 8 | 31.6 | 2.0 | 1.1 | 1.82 | B | A | A |
| Example 9 | 34.3 | 2.0 | 2.0 | 1.00 | A | A | A |
| Example 10 | 37.0 | 2.0 | 2.5 | 0.80 | A | A | A |
| Example 11 | 31.4 | 1.0 | 2.0 | 0.50 | B | A | A |
| Example 12 | 39.0 | 2.0 | 4.0 | 0.50 | A | B | B |
| Example 13 | 29.5 | 2.0 | 0.6 | 3.33 | C | A | A |
| Example 14 | 29.2 | 0.4 | 2.5 | 0.16 | C | A | A |
| Example 15 | 38.0 | 2.0 | 2.0 | 1.00 | A | A | A |
| Example 16 | 38.0 | 1.0 | 1.0 | 1.00 | A | A | A |
| Example 17 | 37.8 | 0.5 | 0.5 | 1.00 | A | A | A |
| Example 18 | 38.3 | 3.0 | 2.5 | 1.20 | A | A | A |
| Example 19 | 38.5 | 5.0 | 5.0 | 1.00 | A | A | B |
| Example 20 | 30.5 | 1.0 | 5.0 | 0.20 | B | A | A |
| Example 21 | 32.5 | 0.1 | 0.3 | 0.33 | B | A | A |
| Example 22 | 31.5 | 5.0 | 1.7 | 2.94 | B | A | B |
| Comparative Example 1 | 54.0 | 2.0 | 2.0 | 1.00 | NG | A | A |
| Comparative Example 2 | 23.0 | 2.0 | 2.0 | 1.00 | NG | A | A |

(*1)For Examples 1 to 11, 13 to 22 and Comparative Examples 1 and 2, the value obtained by dividing the total mass of the inorganic pigment with respect to the total mass of the primer layer by the total mass of the binder resin with respect to the total mass of the primer layer is denoted as A. For Example 12, the value obtained by dividing the total mass of the inorganic pigment with respect to the total mass of the receiving layer by the total mass of the binder resin with respect to the total mass of the receiving layer is denoted as A.
(*2)For Examples 1 to 11, 13 to 22 and Comparative Examples 1 and 2, the thickness of the primer layer is denoted as B (μm), and for Example 12, the thickness of the receiving layer is denoted as B (μm).
(*3)The value is obtained by dividing the A by B.

### REFERENCE SIGNS LIST

100 thermal transfer image-receiving sheet
1 support
2 receiving layer
3 primer layer
6 heat insulation layer
8 back surface layer
61 substrate
62 adhesive layer
63 film

1. A thermal transfer image-receiving sheet comprising one layer constituted only by a receiving layer or two or more layers including a receiving layer provided on one surface of a support, the receiving layer being located on an outermost surface, wherein
any one of layers constituting the thermal transfer image-receiving sheet contains an inorganic pigment, and
when light is allowed to enter a surface on a side of the receiving layer at an incident angle of 45°, ΔL* between receiving angles of 110° and 15° with respect to a specular reflection angle of the incident light is 25 or more and 50 or less.

2. The thermal transfer image-receiving sheet according to claim 1, wherein
the inorganic pigment-containing layer contains a binder resin, and
when a value obtained by dividing a total mass of the inorganic pigment in the inorganic pigment-containing layer by a total mass of the binder resin is denoted as A, and a thickness of the inorganic pigment-containing layer is denoted as B (in m), a value obtained by dividing the A by the B is 0.18 or more and 3.2 or less.

3. The thermal transfer image-receiving sheet according to claim 1, wherein
a primer layer is provided between the support and the receiving layer, and
the primer layer contains an inorganic pigment.

4. A method for producing a print, comprising
combining the thermal transfer image-receiving sheet according to claim 1 and a thermal transfer sheet having a colorant layer to form a thermal transferred image on the receiving layer of the thermal transfer image-receiving sheet.
